(19) United States
(12) Patent Application Publication
(10) Pub. No.: US 2009/0018815 A1
(43) Pub. Date: Jan. 15, 2009

(54) Operating System for a Vehicle

(75) Inventor: Carla Knoop, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/629,983

(22) PCT Filed: Jun. 8, 2005
(86) PCT No.: PCT/EP2005/006128

§ 371 Date: Sep. 15, 2008

(30) Foreign Application Priority Data
Jun. 19, 2004 (DE) 10 2004 029 824.6

(51) Int. Cl. G06F 17/20; G06F 17/27; G06F 3/048

(52) U.S. Cl. 704/8; 704/9; 715/764

(57) ABSTRACT

An operator control system for a vehicle is provided, including an input unit, an output unit, and a speller application with which information can be input character-by-character into the operator control system. The speller application may include a plurality of language-dependent character sets from which a character set can be selected by selecting an operator control language.

### CROSS REFERENCE TO RELATED APPLICATIONS

This application is a national stage of PCT International Application No. PCT/EP2005/006128, filed Jun. 8, 2005, which claims priority under 35 U.S.C. § 119 to German Patent Application No. 10 2004 029 824.6, filed Jun. 19, 2004, the entire disclosures of which are herein expressly incorporated by reference.

### BACKGROUND AND SUMMARY OF THE INVENTION

The present invention relates to an operator control system for a vehicle.

Multimedia operator control systems are being increasingly used in modern vehicles. The command system in the Mercedes Benz S class is an example of this. Such operator control systems generally include an input unit, an output unit and an application with which text can be input character-by-character and which is also referred to below as a speller application. With the speller application it is possible, for example, to use the input unit to input successively, character-by-character, an address as a destination for a navigation application or as an entry in an address book or text as messages to be sent in a communications application.

Due to limited installation space, an extensive keyboard for inputting text is generally not available in a vehicle. For this reason, the available characters for inputting are represented on a visual display unit and are selected and activated by appropriate setting movements using the input unit which is embodied, for example, as a manual activation unit with a plurality of degrees of freedom of adjustment. The individual characters are selected, for example, by rotating and/or sliding the manual activation unit, are activated by pressing and displayed in a text field represented on the display unit.

German patent document DE 37 12 360 A1 describes a method and a device for selecting or inputting a destination for a navigation system in a motor vehicle. The selection of a destination or the inputting of the destination is done by positional rolling of a letter alphabet. The position of a letter or of a number of a destination name is selected step-by-step with a first component of a manual activation unit. The alphabet is run through with a selectable, variable speed or by incremental steps per letter position with a second component of the manual activation unit until the desired letter is reached. In addition to optical display of each selected letter there is acoustic feedback by a voice outputting unit. German patent document DE 100 03 737 A1 describes a method for inputting information into an electric device. The described method can be used, for example, for inputting a destination address into a navigation system, for inputting a telephone number into a telecommunications terminal, for inputting text components of an SMS (short message service) or for inputting commands or other information into a computer.

In the method, after a character of the alphabet has been input, the character, or if one or more characters have already been input before the character which has been input, the character chain formed from the previously input character and the character input last, is compared with information from a comparative set of information. If the character corresponds to the first character of an item of information from the comparative set or when the character chain corresponds to the start of an information item from the comparative set, this information is offered as information to be input.

An object of the present invention is to provide an operator control system for a vehicle with a speller application which can be easily adapted to various operator control languages.

This and other objects and advantages are achieved by an operator control system for a vehicle, according to the present invention, in which a speller application includes a plurality of language-dependent character sets from which a character set can be set by selecting an operator control language. As a result, the character set which is used by the speller application can easily be set by the user as desired by selecting the operator control language. The speller application may be implemented, for example, in an evaluation and control unit as an executable computer program and the language-dependent character sets are stored in a memory unit and are activated by the evaluation and control unit as a function of the selected operator control language.

In an exemplary embodiment of the operator control system, the plurality of character sets are each divided into at least one basic character set and into at least one additional character set, the at least one basic character set including letters and the at least one additional character set including individual characters of the selected operator control language.

As a result, it is possible to use the same basic character sets for a plurality of operator control languages and special characters, such as accented letters ä, ö, ü in the German language or accents in the French language, etc., as at least one additional character set corresponding to the selected language.

In another exemplary embodiment of the operator control system, the display unit displays the at least one basic character set in a first display area and the at least one additional character set in a second display area. As a result, when the operator control language is changed the display areas can be adapted independently of one another to the newly set operator control language. Since many languages, such as German, English, French, Spanish, etc., use the same basic character set, namely Latin letters, when changing between these languages all that is necessary to do is to adapt the additional character set and thus only the second display area to the new language.

The selection of the operator control language for the speller application can be carried out, for example, with a submenu which can be activated by the user by a corresponding input using the input unit. The submenu for selecting the operator control language can be activated here within a main menu and/or within the menu of the speller application.

The activated submenu constitutes, for the selection of the operator control language, for example, a list with languages on the display unit, from which languages one can be selected and set by a corresponding input from the input unit.

In an exemplary embodiment of the operator control system, a language selection which is made within the speller application is effective only for the speller application and generally relates only to the character set associated with the operator control language which has been set. On the other hand, a language selection which has been made in the main menu relates both to the operator control language for the character set of the speller application and to all the menu texts which have been displayed and output for user prompting within the applications and/or functions of the operator control system.

The central setting of the operator control language for all the applications and/or functions of the operator control system allows the user to set the operator control language for the entire operator control system quickly without having to set all the applications and/or functions individually. Selectively changing the operator control language for the speller application allows the user, when necessary, to change a desired foreign language, for example for writing an email or SMS, only within the speller application without changing the operator control language for the entire operator control system.

After the speller application has been exited and/or ended, the newly set operator control language can, for example, be retained.

Alternatively, after the speller application has been ended and/or when the operator control system is restarted, the operator control language of the speller application can be set to the system operator control language set in the main menu.

An advantageous embodiment of the invention is illustrated in the drawings and will be described below.

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block circuit diagram of an exemplary embodiment of an operator control system for a vehicle;

FIG. 2 is an illustration of a display unit of the operator control system from FIG. 1 in a first menu level;

FIG. 3 is an illustration of the display unit in a further menu level;

FIG. 4 is an illustration of the display unit in a first menu level of an activated speller application;

FIG. 5 is an illustration of the display unit in a further menu level of the activated speller application; and

FIG. 6 is an alternative illustration of the display unit in the menu level of the activated speller application.

### DETAILED DESCRIPTION OF THE DRAWINGS

As is apparent from FIG. 1, the operator control system 10 for a motor vehicle includes a display unit 20 which is embodied, for example, as a screen display, a manual activation unit 30, a control and evaluation unit 40 and a memory unit 50. The operator control system 10 enables a user to control a plurality of vehicle systems (not illustrated), such as a navigation system, a heating and air conditioning system, a communication system, for example, a mobile phone, a video system, an audio system, etc.

A speller application 41 may be implemented for inputting text character-by-character in the evaluation and control unit 40 as an executable computer program, and language-dependent character sets for the speller application 41 are stored in the memory unit 50 and are activated by the evaluation and control unit 40 as a function of the selected operator control language. In the illustrated exemplary embodiment, the operator control of all the applications and/or functions and/or subfunctions and/or options and/or status displays of the vehicle systems is carried out in various menu levels of a menu structure by the manual activation unit 30 in conjunction with the display unit.

In addition, predefined applications and/or functions and/or subfunctions and/or options and/or status displays can be controlled in various menu levels of the menu structure in a way which is redundant to the operator control using the manual activation unit 30, with a voice control unit (not illustrated) by a corresponding voice input. The vehicle systems, the manual activation unit 30 and the display unit 20 transmit signals to the evaluation and control unit 40 from which the control and evaluation unit 40 determines current system states and generates and/or makes available corresponding control signals for controlling the vehicle systems.

The manual activation unit 30 has, for example, seven degrees of freedom of adjustment for selecting and/or activating entries displayed on the display unit 20. The manual activation unit 30 can be slid in four directions according to the arrow display in FIG. 1, i.e., in a positive x direction, a negative x direction, a positive y direction or a negative y direction. In addition, the manual activation unit 30 can be rotated about a z axis (not illustrated) which is perpendicular to the plane of the drawing, in the clockwise direction or in the counterclockwise direction, and can be pushed in the direction of the negative z direction, i.e., into the plane of the drawing.

The rotation of the manual activation unit 30 in the clockwise direction moves a cursor on the screen display 20 to the right or downward as a function of a horizontal or vertical orientation of the entries displayed on the screen display 20, and rotation in the counterclockwise direction moves the cursor to the left or upward. Sliding the manual activation unit 30 in FIG. 1 in the upward direction (forward in the direction of the windscreen, i.e., in the positive y direction) moves the cursor on the screen display 20 upward, and sliding in FIG. 1 in the downward direction (toward the rear in the negative y direction) moves the cursor on the screen display 20 downward.

Sliding to the right (in the positive x direction) moves the cursor on the screen display 20 to the right, and sliding to the left (in the negative x direction) moves the cursor to the left. The sliding direction for selecting an entry corresponds here to the orientation of the entries displayed in the active display area. The sliding direction which is orthogonal in each case to the selection sliding direction causes the active display area to be exited. In addition, in order to activate a selected entry it may be necessary to press the manual activation unit 30.

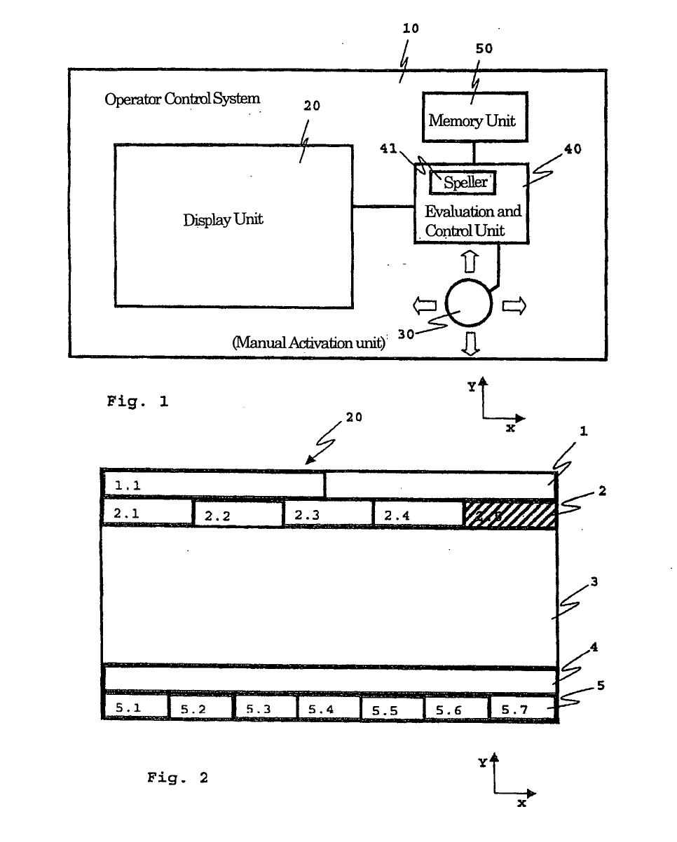

As is apparent from FIG. 2, the screen display 20 includes, in a main menu level, a graphic basic structure of five vertically arranged, horizontal display areas 1 to 5. The screen display 20 is embodied, for example, as an eight-inch screen with a side ratio of 15:9.

In the display areas 1 to 5, it is possible to display one or more entries 1.1 to 5.7 in each case. For example, the display areas 1, 2, 4 and 5 in FIG. 2 each comprise a different number of entries in the first menu level. The graphic basic structure of the third display area 3 is variable over the plurality of different menu levels of the menu structure as a function of an activated application and/or function and/or subfunction and/or option and/or status display, i.e., the graphic configuration of this central display area 3 can be very different. In FIG. 2, the second display area 2 is activated and the hatched entry 2.5 is selected. The hatched display is intended to show that the cursor is on the entry 2.5.

In the illustrated exemplary embodiment, the first display area 1 is embodied, for example, as a status line which displays, as status displays 1.1 to 1.5, various current system states which have been determined by the control and evaluation unit 40 as a function of signals of the vehicle systems. In order to determine the current system states, for example, the signals are evaluated from the navigation system with a locating unit, from the heating and air conditioning system, from the mobile phone, from the video system, from the audio system, etc.

The status line permits, for example, direct access to important functions without changing the application. For example, by activating a letter symbol it is possible to activate and open a speller application 41 in order to input text character-by-character in a communications application or telephone application.

The second display area 2 is embodied as an application line for displaying various selectable and predefinable application groups 2.1 to 2.5, in particular a navigation applications group (Navi), an audio applications group, a telephone/communications applications group (Tel/Com), a video and a vehicle applications group. The activation of one of the applications groups 2.1 to 2.5 which is not already active brings about a changeover into the associated application and activation of the fourth display area 4 in order to display functions and/or subfunctions which are associated with the activated application.

If an application does not have functions or subfunctions, the third display area 3 can be activated by activating this application in the second display area 2, and the options associated with this application can be displayed in order to be controlled. Selecting an application or applications group causes direct activation of at least one other display area and can be carried out by manual inputting using the manual activation unit 30 or by a voice input using the voice control unit. Since none of the entries from one of the five display areas 1 to 5 has yet been activated, the entire screen 20 in FIG. 2 corresponds to the active display area.

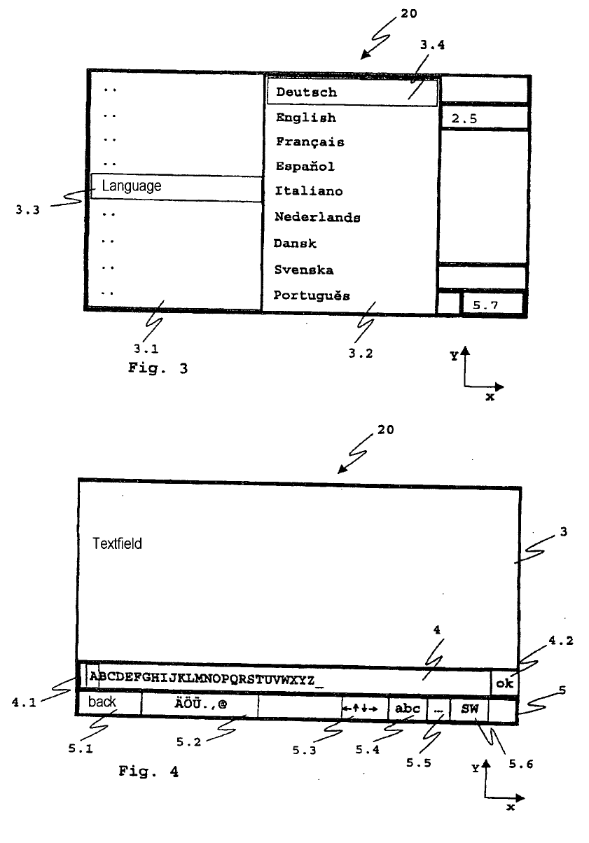

The schematic illustration of the screen display 20 in FIGS. 3 to 6 is adapted with special entries to the operator control of a speller application 41 for inputting text character-by-character.

FIG. 3 shows an illustration of the display unit 20 in a further menu level after the vehicle application has been activated by selecting and activating the entry 2.5 from FIG. 2. After the activation, the display unit 20 displays a list 3.1 with selectable entries which relate to possible vehicle functions. An entry 3.3 “language” with which a submenu, which corresponds in the illustrated exemplary embodiment to a second list 3.2 illustrated on the display unit 20, can be activated in order to select the operator control language is displayed by way of example. The list 3.2 of the submenu “language selection” displays a plurality of entries with selectable languages. The instantaneously set operator control language “Deutsch” (German) is displayed by the framed entry 3.4.

The operator control language is changed by moving the cursor, which is embodied as a frame, onto the desired language by corresponding adjustment movements of the manual activation unit 30, and the language is then selected, for example, by pressing the manual activation unit 30 and subsequently set by the evaluation and control unit 40.

FIG. 4 illustrates the display unit 20 in a first menu level of an activated speller application 41. As is apparent from FIG. 4, the display of the speller application 41 includes the three display areas 3, 4 and 5, with the third display area 3 covering the first and second display areas 1 and 2 from FIG. 2. The display area 3 serves as a text field for displaying the text which has been input. The fourth display area serves to display the basic character set 4.1 from which a subsequent character to be input can be selected by a corresponding setting movement of the manual activation unit 30.

In FIG. 4 the letter “A” is selected and can be activated by further activation of the manual activation unit, i.e., it can be transferred into the text field 3. The fifth display area is used to display the additional character set 5.2 and various entries 5.1 and 5.3 to 5.6 in order to control the speller application 41. It is thus possible, for example, with the entry 5.6, to activate a submenu in order to select the language for the speller function 41. The entry 5.4 can be used, for example, to change between upper case and lower case representation of the characters to be input.

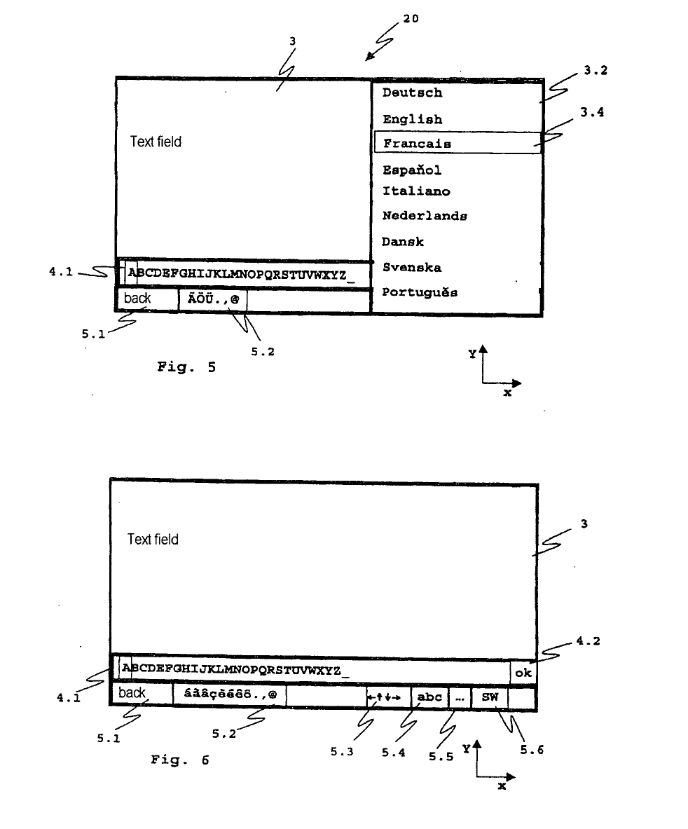

FIG. 5 shows an illustration of the display unit 20 after activation of the control button 5.4 by means of which the “language selection” sub menu is activated and displayed as a list 3.2 on the display unit in order to select the operator control language. As is also apparent from FIG. 5, an entry 3.4, which represents the language “Francais” (French), is selected by a corresponding adjustment movement of the manual activation unit 30.

After the entry has been activated, the character set of the speller application 41 for the operator control language French is selected according to the illustration from FIG. 6. The various, language-dependent character sets are stored, for example, in the memory unit 50 and are activated by the evaluation and control unit 40 in accordance with the selected operator control language.

As is apparent from FIG. 6, the basic character set 4.1 includes the same characters as when the operator control language “Deutsch” (German) has been set. In contrast, the additional character set 5.2 displays the special characters of the French language and is adapted to the newly set operator control language “French”. When a language is selected with a different basic character set, for example, when the languages Russian, Greek, etc. are selected, both the basic character set 4.1 and the additional character set 5.2 are adapted to the newly set operator control language.

As is apparent from FIG. 4 to 6, the speller application 41 includes various characters such as letters and/or numbers and/or symbols which can be input one after the other, for example, in order to delete characters or to change between upper case and lower case representation, word entries such as “back” for triggering functions, and entries in the form of icons, for example, for calling subfunctions.

The characters which are arranged horizontally in the display area 4.1 or 5.2 are selected by horizontally sliding or rotating the manual activation unit 30. A changeover between the vertically arranged display areas 3 to 5 of the speller application 41 is carried out by vertically sliding the manual activation unit 30. A character or an entry is activated by pressing the manual activation unit 30.

The speller application 41 includes two speller functions, which are referred to as search spellers or editor spellers. The search speller is used to input characters in order to match predefined list entries as necessary, for example, for inputting a destination address within a navigation application, in which a destination location can be selected from a predefined list. By selecting a character with the cursor or activating the character by pressing the manual activation unit 30, the selected character is matched with a list and the result is displayed in a display area, i.e., in the displayed exemplary embodiment in the text display field 3. The editor speller is used to input or process text inputs, for example, to compose messages which are sent as an SMS or email in the communications application.

After the speller application 41 has been activated, for example, by the navigation application or the communications application, the cursor may be in the display area of the basic character set 4.1, in a centered position with respect to the available characters. Given an even number of characters, the orientation of the cursor is to the left. After each selection of a character, the cursor remains positioned on the same character.

When there is a changeover between the basic character set 4.1 and the additional character set 5.2 by vertically sliding the manual activation unit 30, the cursor is placed on the character which is vertically above or vertically below it. If there is no character available in the vertical direction, the cursor jumps to the closest character to the right or left of the corresponding position. If the characters to the right and left are the same distance away, the cursor jumps to the left-hand character.

By activating the entry 5.5 from FIG. 4 or FIG. 6, it is possible to display further additional character sets with further characters instead of the previous additional character set, and the cursor remains positioned on the entry 5.5. A changeover between the additional character sets is carried out by renewed activation of the entry 5.5. The sequence corresponds to a serial memory, i.e., all the possible additional character sets have to be run through in order to return, by activating the entry 5.5, to the originally displayed additional character set.

After the speller application 41 has been exited and/or ended, the newly set operator control language can be maintained for the future activations of the speller application 41 or can be set to the system operator control language which has been set in the main menu. Thus, it is possible to provide, for example, that when the user exits the speller application 41 he can select between the options of retaining the speller operator control language or resetting to the system operator control language.

Alternatively, the operator control language of the speller application 41 can be reset to the system operator control language only when the system is restarted.

Since the operator control system according to the invention makes available a speller application with a plurality of language-dependent character sets, from which a character set can be set by selecting an operator control language, the user is advantageously able to set the operator control language of the speller application easily according to his wishes.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. An operator control system for a vehicle comprising:
an input unit;
an output unit; and
a speller application with which information can be input character-by-character into the operator control system;
wherein the speller application includes a plurality of language-dependent character sets from which a character set can be selected by selecting an operator control language.

12. The operator control system as claimed in claim 11, wherein:
the plurality of character sets are each divided into at least one basic character set and into at least one additional character set;
the basic character set comprises letters; and
the additional character set comprises individual characters of the selected operator control language.

13. The operator control system as claimed in claim 12, wherein character sets of at least two operator control languages comprise a same basic character set and different additional character sets.

14. The operator control system as claimed in claim 12, wherein the output unit is configured to display the basic character set in a first display area and the additional character set in a second display area.

15. The operator control system as claimed in claim 11, wherein selection of the operator control language for the speller application can be carried out by a submenu activated from a main menu or from the speller application by a corresponding input from the input unit.

16. The operator control system as claimed in claim 15, wherein the submenu comprises a list of languages on the display unit, from which languages one can be selected and set by a corresponding input from the input unit.

17. The operator control system as claimed in claim 15, wherein when a change of language occurs, the contents of the basic character set which are displayed on the display unit or of the displayed additional character set can be set to correspond to a selected language.

18. The operator control system as claimed in claim 15, wherein:
a language selection made within the speller application is effective only for the speller application; and
a language selection made in the main menu is effective for all applications and functions in the operator control system.

19. The operator control system as claimed in claim 18, wherein the operator control language selected within the speller application is retained after use of the speller application has ended.

20. The operator control system as claimed in claim 18, wherein the operator control language of the speller application is set to the system operator control language after use of the speller application has ended or when the operator control system is restarted.

21. The operator control system as claimed in claim 13, wherein the output unit is configured to display the basic character set in a first display area and to display the additional character set in a second display area.

22. The operator control system as claimed in claim 12, wherein selection of the operator control language for the speller application can be carried out by a submenu activated from a main menu or from the speller application by a corresponding input from the input unit.

23. The operator control system as claimed in claim 13, wherein selection of the operator control language for the speller application can be carried out by a submenu activated from a main menu or from the speller application by a corresponding input from the input unit.

24. The operator control system as claimed in claim 14, wherein selection of the operator control language for the speller application can be carried out by a submenu activated from a main menu or from the speller application by a corresponding input from the input unit.

25. The operator control system as claimed in claim 16, wherein when a change of language occurs, the contents of the basic character set which are displayed on the display unit or of the displayed additional character set can be set to correspond to a selected language.

26. The operator control system as claimed in claim 16, wherein a language selection made within the speller application is effective only for the speller application and a language selection made in the main menu is effective for all applications and functions in the operator control system.

27. The operator control system as claimed in claim 17, wherein a language selection made within the speller application is effective only for the speller application and a language selection made in the main menu is effective for all applications and functions in the operator control system.

28. The operator control system as claimed in claim 26, wherein the operator control language selected within the speller application is retained after use of the speller application has ended.

29. The operator control system as claimed in claim 27, wherein the operator control language selected within the speller application is retained after use of the speller application has ended.

30. The operator control system as claimed in claim 26, wherein the operator control language of the speller application is set to the system operator control language after use of the speller application has ended or when the operator control system is restarted.
